(19) United States
(12) Patent Application Publication
(10) Pub. No.: US 2014/0306013 A1
(43) Pub. Date: Oct. 16, 2014

(54) PORTABLE BAR-CODE SCANNER

(71) Applicant: OPTICON, INC., Renton, WA (US)

(72) Inventors: Michael J. Waters, Tukwila, WA (US); Scott McGhee, Seattle, WA (US); Kenneth Y. Ogami, Kirkland, WA (US); Jiang Qin, Renton, WA (US)

(73) Assignee: Opticon, Inc., Renton, WA (US)

(21) Appl. No.: 13/860,289

(22) Filed: Apr. 10, 2013

(51) Int. Cl. G06K 7/10

(52) U.S. Cl. CPC G06K 7/10881
USPC 235/462.15; 235/462.45; 235/462.46

(57) ABSTRACT

A portable scanning apparatus is disclosed, which may include a bar code scanner module incorporated within a housing; a portable computer memory assembled to the bar code scanner and incorporated within said housing, wherein the computer memory is operable to receive and store data obtained by the bar code scanner, and wherein the assembly of the bar code scanner and the portable computer memory within said housing forms a compact and portable package.

### BACKGROUND OF THE INVENTION

This application relates in general to scanning devices and in particular to a portable scanning apparatus able to operate independently of a host system.

Portable bar code scanners are known in the art. Most such scanners have a size and form factor suitable for being held comfortably in the hand of a human operator. This device size may be suitable for applications such as scanning bar codes in supermarkets or other environments in which an employee is expected to carry work-related equipment around. However, the portability and flexibility of a scanner of this size may be limited outside the context of the work environment described above.

Accordingly, there is a need in the art for a scanner having more flexibility than what is currently available in the art.

### SUMMARY OF THE INVENTION

According to one aspect, the present invention is directed to a portable scanning apparatus that may include a bar code scanner module incorporated within a housing; a portable computer memory assembled to the bar code scanner and incorporated within said housing, wherein the computer memory is operable to receive and store data obtained by the bar code scanner, and wherein the assembly of the bar code scanner and the portable computer memory within said housing forms a compact and portable package.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a plan view of a memory stick scanner in accordance with an embodiment of the present invention;

FIG. 2 is a perspective view of a scanner module in accordance with an embodiment of the present invention;

FIG. 3 is a plan view of the scanner module of FIG. 2; and

FIG. 4 is a block diagram of a computer system useable in conjunction with an embodiment of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

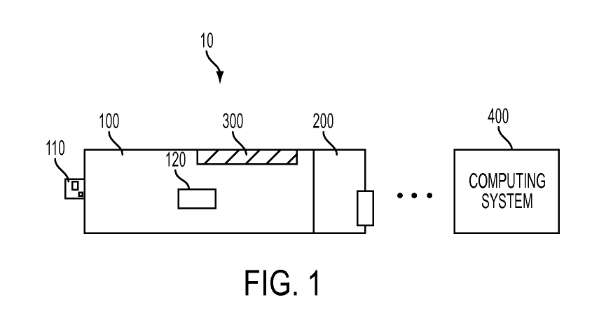

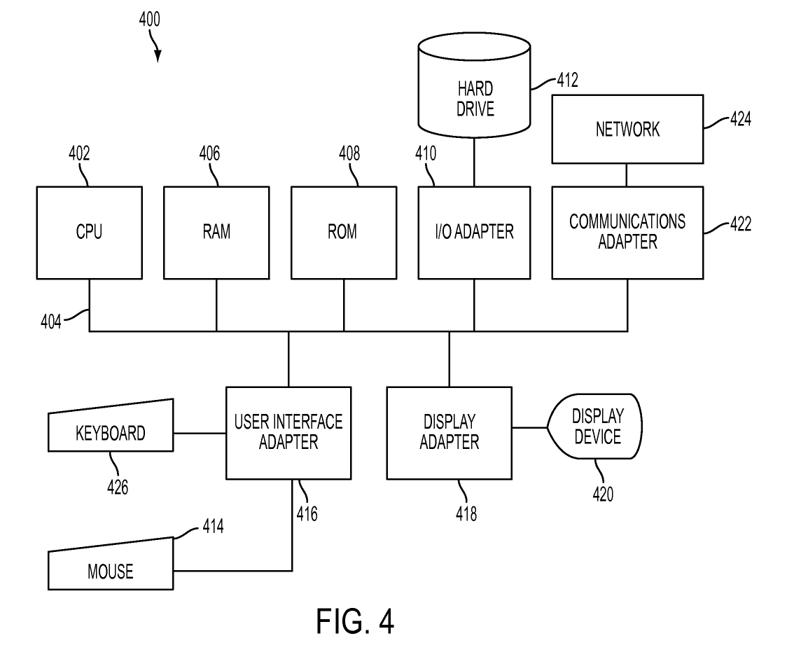

FIG. 1 is a plan view of a portable scanning system 10 in accordance with an embodiment of the present invention. Scanning system 10 may include memory stick (also known as a thumb drive) 100, scanner module 200, and/or battery 300, which is preferably rechargeable. Scanning system 10 may periodically be connected to computing system 400 to upload and/or download data, and/or to charge battery 300. Computing system 400 is discussed in greater detail in connection with FIG. 4.

Scanning apparatus 10 preferably has a form factor that is longer (where length is the left-to-right dimension in FIG. 1) than it is wide (where width is the up-down dimension in FIG. 1). Moreover, scanning apparatus 10 may be sized so as to: (a) fit into a pocket, such as shirt pocket or pants pocket; (b) be attachable to a neck strap; and/or (c) be attachable to a standard personal keychain without being unduly cumbersome.

Memory stick 100 may be used to receive and store scan data from scanner module 200. Memory stick 100 may also be used to store operational data for scanner module 200, which may be delivered to scanner module 200 as needed. For instance, if different operating conditions and different scanning tasks require different scan speeds, different lighting, and/or different analog scan data processing (such as, for instance, using different thresholds for distinguishing between a logic “0” level and a logic “1” scan data value), then an entire range of scanner module operating data could be stored in memory stick 100, in computing system 400, or in a combination of the foregoing.

Battery 300 may be rechargeable, but need not be. Disposable batteries may be employed instead. Battery 300 may be configured so as to be removable from scanning apparatus 10 for recharging purposes, and/or to enable a substitute battery to installed within scanning apparatus 10. However, alternatively, scanning apparatus 10 could be configured so that a rechargeable battery 300 is permanently affixed within scanning apparatus 10.

Scanning system 10 may further include connector 110 (for connecting to host computer 400, or other computing system) and/or activation button 120. Memory stick 100 may include Random-Access Memory (RAM), Read-Only Memory (ROM), Flash memory, or any combination of the foregoing. Any suitable type of memory devices may be used for the RAM or ROM memory circuits. Moreover, the present invention is not limited to above-listed memory types. In one alternative embodiment, scanning system 10 could include a Radio Frequency (RF) transceiver for transmitting scan data wirelessly to another device from scanning system 10 and/or for transmitting data to scanning system 10 from a remotely located device. Memory stick 100 may be used to store scan data obtained by scanning module 200. However, memory stick 100 preferably includes enough data storage capacity to store a large amount of data from sources other than scanning module 200.

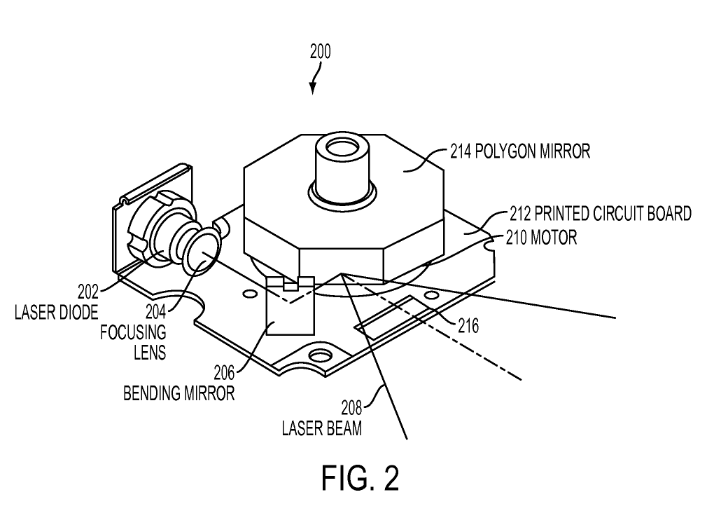

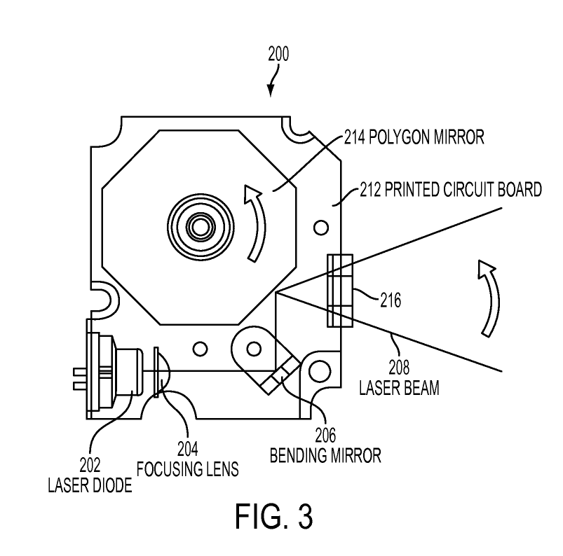

FIG. 2 is a perspective view of scanner module 200 in accordance with an embodiment of the present invention. Scanner module 200 may include laser diode 202, focusing lens 204, bending mirror 206, laser beam 208, motor 208, motor 210, printed circuit board 212, polygon mirror 214, and/or detector 216. Moreover, scanner module 200 may be powered either by battery 300 (FIG. 1), by a power source in a docking station such as computing system 400, or by a combination of the foregoing. FIG. 3 is a plan view of scanner module 200 of FIG. 2. Suitable connections may be implemented (not shown) to convey signal data from detector 216 to electronic circuitry on scanner module 200 (or on a device in communication with scanner module 200) to receive, process, and store scan data from detector 216, as is known in the art.

The scanner module shown in FIGS. 2 and 3 is exemplary. The present invention is not limited to the specific implementation of scanner module shown therein. Any one of several possible configurations of a modern scanner could be used in conjunction with a memory stick in embodiments of the present invention.

When not connected to a host device, scanning apparatus 10 preferably runs on power from battery 300 which may be rechargeable and/or removable from scanning apparatus 10. In this mode of operation, a human operator may initiate operation of scanner module 200 by pressing button 120. Scanner module 200 may then scan a bar code, or other image, and receive scan data from the image. The scan data may then be digitized and stored either in memory within scanner module 200 or in memory stick 100. Computational power sufficient to operate scanner module 200 and to coordinate the transfer of data to memory stick 100 may be incorporated within a processor within scanning apparatus 10. This processor (not shown) may be incorporated within scanner module 200, or within memory stick 100. Alternatively, some data processing capability may be incorporated within processors within both memory stick 100 and scanner module 200. Scanning apparatus 10 may continue operating in this mode until battery 300 needs recharging or replacement, or until memory stick 100 has no more storage space.

Scanning apparatus 10 may be connected to a host device such as computing system 400. When connected in this manner, scanning apparatus 10, and particularly the memory stick 100 portion thereof, may be configured to appear to a host system, such as computing system 400, as an external drive having data accessible by the host system.

Scanning apparatus 10 may be configured to self-install upon being connected to a host system such as computing system 400. At least one conductive path between computing system 400 and scanning system 10 may be used to charge battery 300. Separately, scanning system 10 may upload stored scan data from scanning module 200 and/or memory stick 100 to a memory device within computing system 400. Scanning system 10 may also download data from a host device, which data could include ordinary payload data for storage in memory stick 100 which is not relevant to scanner module 200. Scanning system 100 could also download data that includes operational parameters for the operation of scanner module 200.

FIG. 4 is a block diagram of a computing system 400 adaptable for use with one or more embodiments of the present invention. For instance, computing system 400 may serve as a host computer to which scanning system 10 may be coupled to. Moreover, a computing system incorporating one or more of the components (depicted with individual blocks in FIG. 4) may be incorporated within scanner module 200 to store operational data for controlling the scanning operation (i.e. to control motor speeds, do initial processing on scan data, etc.), to store scan data received at detector 216, to control data transfer between scanner module 200 and memory stick 100, and/or other functions useful for the operation of scanning apparatus 10.

In computing system 400, central processing unit (CPU) 402 may be coupled to bus 404. In addition, bus 404 may be coupled to random access memory (RAM) 406, read only memory (ROM) 408, input/output (I/O) adapter 410, communications adapter 422, user interface adapter 406, and display adapter 418.

In an embodiment, RAM 406 and/or ROM 408 may hold user data, system data, and/or programs. I/O adapter 410 may connect storage devices, such as hard drive 412, a CD-ROM (not shown), or other mass storage device to computing system 400. Communications adapter 422 may couple computing system 400 to a local, wide-area, or global network 424. User interface adapter 416 may couple user input devices, such as keyboard 426, scanner 428 and/or pointing device 414, to computing system 400. Moreover, display adapter 418 may be driven by CPU 402 to control the display on display device 420. CPU 402 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A portable scanning apparatus comprising:
a bar code scanner module incorporated within a housing;
a portable computer memory assembled to the bar code scanner and incorporated within said housing, wherein the computer memory is operable to receive and store data obtained by the bar code scanner, and wherein the assembly of the bar code scanner and the portable computer memory within said housing forms a compact and portable package.

2. The portable scanning apparatus of claim 1 wherein the portable computer memory is a USB thumb drive.

3. The portable scanning apparatus of claim 1 wherein the bar code scanner is operable to obtain operational data from the portable computer memory.

4. The portable scanning apparatus of claim 1 wherein the scanning apparatus is configured to be attachable to and able to communicate with a personal computer.

5. The portable scanning apparatus of claim 1 further comprising:
a radio-frequency transceiver operable to enable wireless communication between the scanning apparatus and a remotely located device.

6. The portable scanning apparatus of claim 1 wherein the portable computer memory is configured to receive and store data from devices other than the bar code scanner module.

7. The portable scanning apparatus of claim 1 wherein the scanning apparatus is operable to self-install upon being plugged into a host computer.

8. A method, comprising:
providing a compact scanner module;
coupling a memory stick to the compact scanner module, thereby forming a scanning apparatus within a compact package; and
establishing data communication between the memory stick and the scanner module.

9. The method of claim 8 comprising:
scanning an image using the scanner module; and
obtaining image data indicative of the scanned image.

10. The method of claim 9 further comprising:
storing the obtained image data in said memory stick.

11. The method of claim 10 further comprising:
coupling the scanning apparatus to a host computer system.

12. The method of claim 11 further comprising:
uploading the stored image data from the memory stick to the host computer system.

13. The method of claim 11 further comprising:
the scanning apparatus conducting a self-installation procedure in conjunction with the host computer system upon being coupled thereto.
